(19) United States
(12) Patent Application Publication
(10) Pub. No.: US 2021/0276103 A1
(43) Pub. Date: Sep. 9, 2021

(54) STAGGERED TOOTH GROOVE CUTTER

(71) Applicant: Honda Motor Co., Ltd., Tokyo (JP)

(72) Inventor: Justin Richard Harpst, Degraff, OH (US)

(21) Appl. No.: 16/809,972

(22) Filed: Mar. 5, 2020

(51) Int. Cl. B23B 27/14; B23B 51/04

(52) U.S. Cl. CPC B23B 27/145; B23B 51/0406; B23C 5/18; B23B 2200/242; B23B 2251/04; B23B 2200/087

(57) ABSTRACT

A cutting tool is described herein that includes a body configured to rotate around a rotational axis. The cutting tool also includes a first plurality of cutting teeth each extending radially outwardly from the body, each cutting tooth of the first plurality of cutting teeth includes a cutting section positioned on a first side of a rotational plane that extends radially outwardly from the rotational axis and a non-cutting section positioned on a second, opposite side of the rotational plane. The cutting tool also includes a second plurality of cutting teeth each extending radially outwardly from the body, each cutting tooth of the second plurality of cutting teeth includes a cutting section positioned on the second side of the rotational plane and a non-cutting section positioned on the first side of the rotational plane.

### BACKGROUND

The present disclosure relates generally to machining of metal work pieces and, more specifically, to a cutting device used to cut grooves in a metal work piece.

Grooves may need to be cut into interior surfaces of substantially cylindrical openings in a work piece. For example, there are grooves that need to be produced in the walls or projections of walls in cylindrical depressions that are found in various vehicle parts or other work pieces, such as depressions that might hold rotating mechanisms (e.g., gears, pulleys, etc.). Such grooves are usually cut using traditional groove cutting tools that have teeth for cutting the grooves. The cutting tool is rotated at high speed using a spindle holding the cutting tool, and the spindle is maneuvered around the cutting surface (in an orbital motion) within the walls of the cylindrical opening to cut the grooves into the desired surface. The material removed to cut the grooves forms what may be referred to as a chip. Typically, the chip is the same width as the groove. It is desirable for the chips to be completely removed from the work piece before further operations are performed on the work piece. However, when the chip is the same width as the groove, the chip may become stuck in the groove and require manual intervention to remove the chip from the work piece. This manual intervention adds time, manpower, and/or cost to the process of preparing the work piece for further operations.

### BRIEF DESCRIPTION

In one aspect, a cutting tool is provided. The cutting tool includes a substantially circular body configured to rotate around a rotational axis. The cutting tool also includes a first plurality of cutting teeth each extending substantially radially outwardly from the body, each cutting tooth of the first plurality of cutting teeth includes a cutting section and a non-cutting section, wherein the cutting section is positioned on a first side of a rotational plane that extends radially outwardly from the rotational axis of the cutting device and the non-cutting section is positioned on a second, opposite side of the rotational plane. The cutting tool also includes a second plurality of cutting teeth each extending radially outwardly from the body, each cutting tooth of the second plurality of cutting teeth includes a cutting section and a non-cutting section, wherein the cutting section is positioned on the second side of the rotational plane and the non-cutting section is positioned on the first side of the rotational plane. Wherein each cutting section includes a cutting surface positioned a first distance from the rotational plane and each non-cutting section includes a non-cutting surface positioned a second distance from the rotational plane.

In another aspect, a groove cutting device is provided. The groove cutting device includes a spindle coupled to a motor for rotating the spindle about a rotational axis and in an orbital motion. The groove cutting device also includes a cutting tool coupled to the spindle. The cutting tool includes a substantially circular body configured to rotate around a rotational axis. The cutting tool also includes a first plurality of cutting teeth each extending substantially radially outwardly from the body, each cutting tooth of the first plurality of cutting teeth includes a cutting section and a non-cutting section, wherein the cutting section is positioned on a first side of a rotational plane that extends radially outwardly from the rotational axis of the cutting device and the non-cutting section is positioned on a second, opposite side of the rotational plane. The cutting tool also includes a second plurality of cutting teeth each extending radially outwardly from the body, each cutting tooth of the second plurality of cutting teeth comprises a cutting section and a non-cutting section, wherein the cutting section is positioned on the second side of the rotational plane and the non-cutting section is positioned on the first side of the rotational plane. Wherein each cutting section includes a cutting surface positioned a first distance from the rotational plane and each non-cutting section includes a non-cutting surface positioned a second distance from the rotational plane.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a perspective view of an example work piece;

FIG. 2 is a schematic diagram showing the rotational movement of a cutting device during a known machining operation, for example, cutting of a groove into an interior surface of the work piece shown in FIG. 1;

FIG. 3 is a top view of an exemplary embodiment of a cutting tool that may be used in the machining operation shown in FIG. 2;

FIG. 4 is a perspective view of a cutting tooth included in the cutting tool shown in FIG. 3;

FIG. 5 is a cross-sectional view of a first type of cutting tooth included in the cutting tool shown in FIG. 3;

FIG. 6 is a cross-sectional view of a second type of cutting tooth included in the cutting tool shown in FIG. 3;

FIG. 7 is an alternative embodiment of the cutting tooth shown in FIG. 5; and

FIG. 8 is an alternative embodiment of the cutting tooth shown in FIG. 6.

### DETAILED DESCRIPTION

The embodiments described herein relate generally to a cutting device used to cut a groove in a metal work piece. A number of embodiments of a groove cutting device or tool for cutting a groove into a wall or projections in the wall of a substantially cylindrical hole in a work piece are disclosed. The groove cutting devices described herein are configured to produce chips that are easier to remove from the work piece than chips produced by known cutting devices.

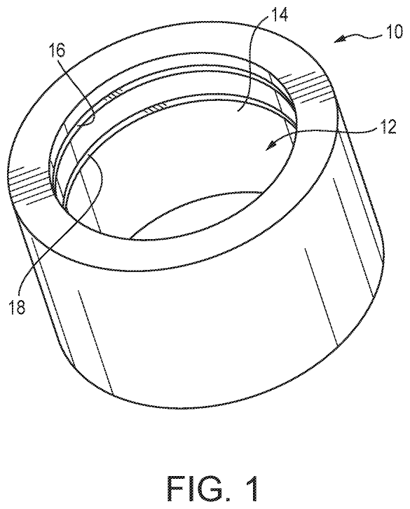

FIG. 1 is a perspective view of an example work piece 10. In the exemplary embodiment, work piece 10 includes a substantially cylindrical opening 12 defined by a substantially cylindrical wall 14. In this example, two parallel grooves 16, 18 are shown having been cut into wall 14. The work piece 10 is shown having been machined according to the disclosed method.

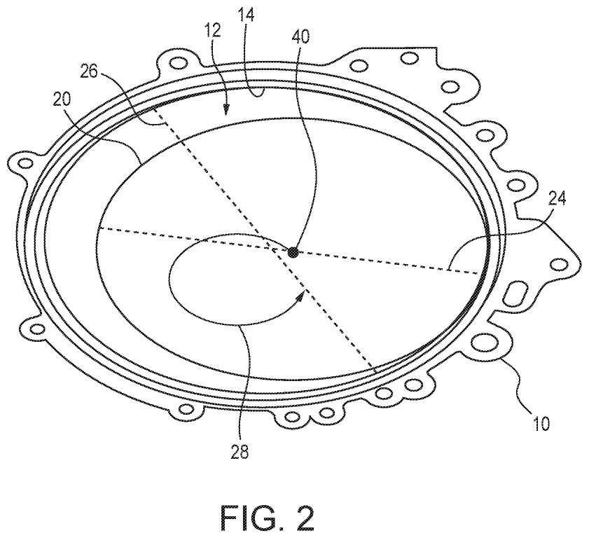

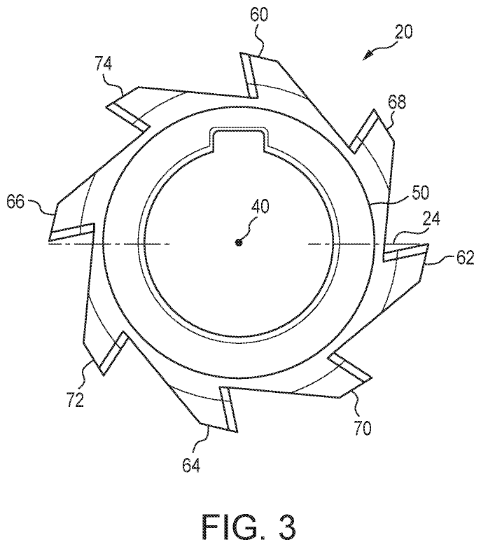

FIG. 2 is a diagram showing a machining motion of a known groove cutting device. In the exemplary embodiment, a cutting tool 20 (see FIG. 3) is removably coupled to the groove cutting device. The groove cutting device includes a spindle, which holds the groove cutting tool 20. The cutting tool 20 may be inserted and removed from the spindle. A motor rotates the spindle at a high rate of speed to rotate the cutting tool about a rotational axis 40 (see FIG. 3) for cutting grooves into walls or other structures in, for example, wall 14 of the work piece 10. An outer diameter 24 of the groove cutting tool 20 is slightly less than an inner diameter 26 of the opening 12 of the work piece 10 so that the groove cutting tool 20 can be lowered and removed from the opening 12 without interference.

The groove cutting device also provides an orbital motion to the groove cutting tool 20 to orbit the groove cutting tool 20 around the wall 14 of the work piece 10 such that the desired grooves are cut around the entire wall, or into all wall projections, as desired. The groove cutting tool rotational axis 40 is orbited around a longitudinal axis of the work piece opening 12 to put the outer surface of the cutting tool 20 into contact with the structures being machined for cutting the desired grooves, with this orbital motion shown generally by rotation arrow 28. In this manner, the desired surfaces of the work piece wall 14 are machined as intended.

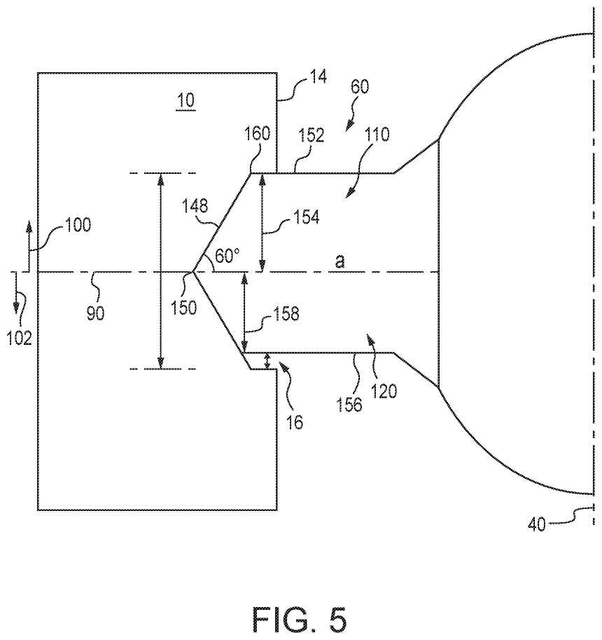

FIG. 3 shows an exemplary embodiment of the groove cutting tool 20 that may be included in the groove cutting device described above. In the exemplary embodiment, the groove cutting tool 20 includes a substantially circular body 50 configured to rotate about the rotational axis 40 (also see FIG. 5). The tool 20 includes a plurality of cutting teeth configured to cut a groove in a work piece, for example, groove 16 in work piece 10 (shown in FIG. 1). In the exemplary embodiment, groove cutting tool 20 includes two types of cutting teeth. More specifically, the tool 20 includes a first plurality of cutting teeth and a second plurality of cutting teeth, each extending substantially radially outwardly from the body 50.

For example, the first plurality of cutting teeth may include a first cutting tooth 60, a second cutting tooth 62, a third cutting tooth 64, and a fourth cutting tooth 66. The second plurality of cutting teeth may include a fifth cutting tooth 68, a sixth cutting tooth 70, a seventh cutting tooth 72, and an eighth cutting tooth 74. In the exemplary embodiment, the first cutting tooth 60 is positioned on a radially opposite side of the body 50 as the third cutting tooth 64. Furthermore, the second cutting tooth 62 is positioned on a radially opposite side of the body 50 as the fourth cutting tooth 66. Moreover, the fifth cutting tooth 68 is positioned on a radially opposite side of the body 50 as the seventh cutting tooth 72 and the sixth cutting tooth 70 is positioned on a radially opposite side of the body 50 as the eighth cutting tooth 74. Furthermore, each of the first plurality of cutting teeth alternates with the second plurality of cutting teeth around the circumference of the body 50. Although described as each including four cutting teeth, the first and second plurality of cutting teeth may include any number of cutting teeth that allows the cutting tool 20 to function as described herein.

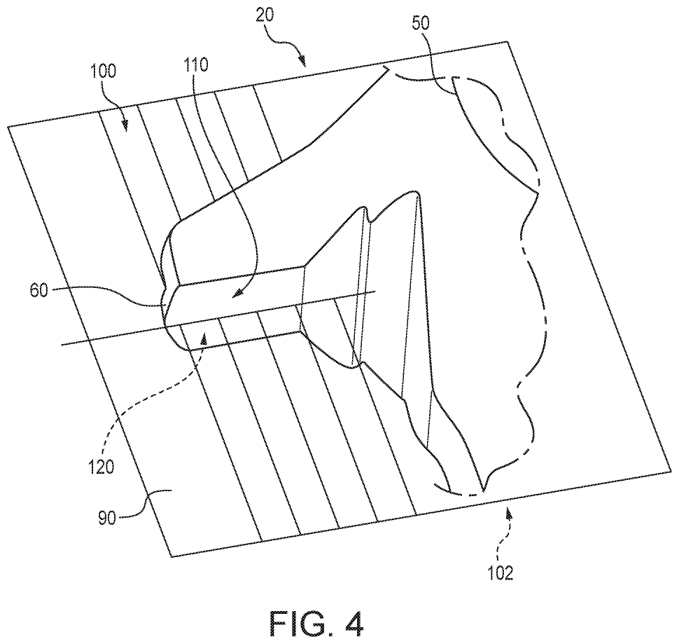

FIG. 4 is a perspective view of a cutting tooth of a cutting device, for example, cutting tooth 60 of groove cutting tool 20 (shown in FIG. 3). A rotational plane 90 is defined as a plane that is perpendicular to, and extends radially from, rotational axis 40 (shown in FIG. 3). In the exemplary embodiment, each cutting tooth includes a cutting section and a non-cutting section. The cutting section is positioned on a first side 100 of the rotational plane 90 (e.g., above rotational plane 90 as illustrated in FIG. 4) and the non-cutting section is positioned on a second, opposite side 102 of the rotational plane 90 (e.g., below rotational plane 90 as illustrated in FIG. 4). For example, cutting tooth 60 includes a cutting section 110 positioned on first side 100 of rotational plane 90 and a non-cutting section 120 positioned on second side 102 of rotational plane 90.

FIG. 5 is a cross-sectional view of a cutting tooth, for example, cutting tooth 60 which is shown as an example of one of the first plurality of cutting teeth. As described above, cutting tooth 60 includes cutting section 110 positioned on the first side 100 of the rotational plane 90, and non-cutting section 120 positioned on the second side 102 of the rotational plane 90. Cutting tool 20 is shown in the process of cutting groove 16 into wall 14 of work piece 10.

In the exemplary embodiment, cutting section 110 includes a cutting surface 148. Cutting surface 148 extends from a first point 150 along an outer surface of cutting section 110 to an upper surface 152 of cutting section 110. Along the upper surface 152, the cutting surface 148 is positioned a first distance 154 from rotational plane 90. Non-cutting section 120 includes a non-cutting surface 156 positioned a second distance 158 from rotational plane 90. In the exemplary embodiment, the second distance 158 is less than the first distance 154. In the specific example shown in FIG. 5, the cutting surface 148 at upper surface 152 is 1.0 mm from rotational plane 90 and the non-cutting surface 156 is 0.8 mm from the rotational plane 90.

The material removed from work piece 10 by cutting tool 20 to cut the groove forms what may be referred to as a chip of removed material. The chip is generally the same width as the portion of the cutting tool 20 that is removing material from the work piece 10. For example, the width of the chip formed by cutting tooth 60 would generally be equal to the length of cutting surface 148 from first point 150 to a second point 160 on cutting tooth 60. In the exemplary embodiment where cutting surface 148 at upper surface 152 is 1.0 mm from rotational plane 90, and cutting surface 148 is angled at approximately 60 degrees from the rotational plane 90, the chip formed would be approximately 1.15 mm wide.

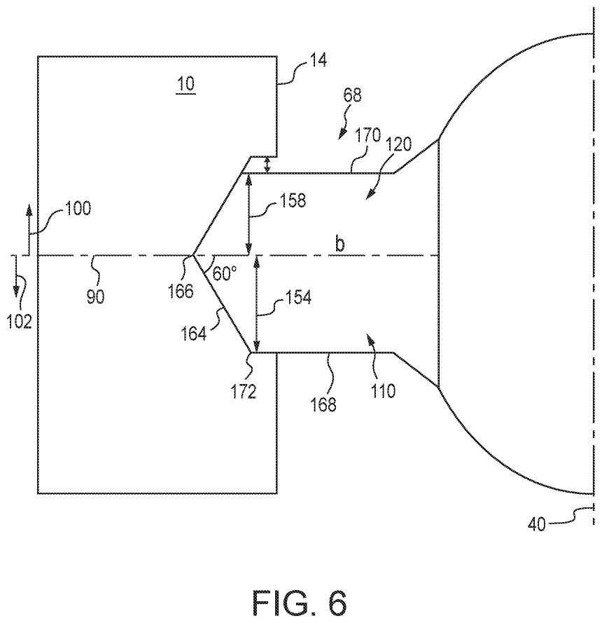

FIG. 6 is a cross-sectional view of a cutting tooth, for example, cutting tooth 68 which is shown as an example of one of the second plurality of cutting teeth. As described above, cutting tooth 68 includes cutting section 110 positioned on the second side 102 of the rotational plane 90, and non-cutting section 120 positioned on the first side 100 of the rotational plane 90.

In the exemplary embodiment, cutting section 110 includes a cutting surface 164. Cutting surface 164 extends from a first point 166 along an outer surface of cutting section 110 to a lower surface 168 of cutting section 110. Along the lower surface 168, the cutting surface 164 is positioned the first distance 154 from rotational plane 90. Non-cutting section 120 includes a non-cutting surface 170 positioned the second distance 158 from rotational plane 90. In the exemplary embodiment, the second distance 158 is less than the first distance 154. In the specific example shown in FIG. 6, the cutting surface 164 at the lower surface 168 is 1.0 mm from rotational plane 90 and the non-cutting surface 170 is 0.8 mm from the rotational plane 90.

As described above with respect to cutting tooth 60, a width of a chip formed by cutting tooth 68 would generally be equal to the length of cutting surface 164 from first point 166 to a second point 172 on cutting tooth 68. In the exemplary embodiment where cutting surface 164 at the lower surface 168 is 1.0 mm from rotational plane 90, and cutting surface 164 is angled at approximately 60 degrees from the rotational plane 90, the chip formed would be approximately 1.15 mm wide.

In operation, cutting surfaces 148 of the first plurality of cutting teeth (shown in FIG. 5) cut a first portion of a groove, for example, groove 16. For example, cutting surfaces 148 of the first plurality of cutting teeth cut a portion of groove 16 on first side 100 of the rotational plane 90. Moreover, cutting surfaces 164 of the second plurality of cutting teeth (shown in FIG. 6) cut a second portion of groove 16, for example, a portion of groove 16 on second side 102 of the rotational plane 90. The width of groove 16 is defined by the first distance 154 in the first axial direction from the rotational plane 90 combined with the first distance 154 in the second axial direction from the rotational plane 90. In the exemplary embodiment where first distance 154 equals 1.0 mm, the final width of groove 16 would be 2.0 mm. Notably, the 2.0 mm groove is cut while producing chips that are approximately 1.15 mm wide. The narrower chips are less likely to become stuck and/or wedged within groove 16 than a chip that is approximately the same width as the groove. Producing chips that are narrower than the final width of the groove reduces the number of chips stuck and/or wedged within the groove after machining. This reduces process time by reducing the amount of manual intervention needed to remove chips from the work piece 10.

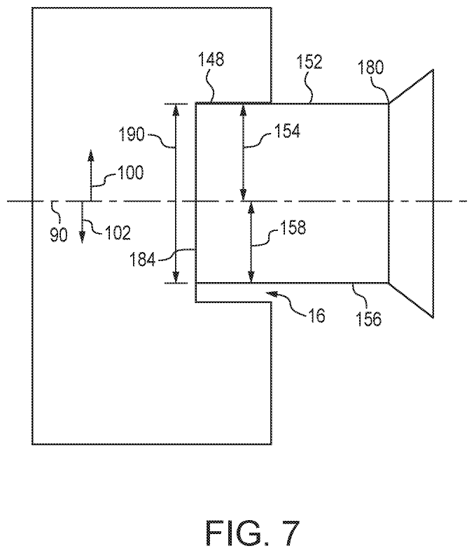

FIG. 7 is an alternative embodiment of cutting tooth 60. In the alternative embodiment, cutting surface 148 may extend from a first point 180 on cutting tooth 60 along the upper surface 152 of cutting tooth 60, and along a substantially flat surface 184. Upper surface 152 is positioned the first distance 154 from rotational plane 90. The alternative embodiment of cutting tooth 60 also includes non-cutting surface 156, positioned the second distance 158 from rotational plane 90. In contrast to the embodiment shown in FIG. 5, in the alternative embodiment of cutting tooth 60, cutting surface 148 does not extend from point 150, but rather, extends along flat surface 184. In the alternative embodiment, cutting surface 148 cuts a first portion 190 of groove 16.

A chip formed by the alternative embodiment of cutting tooth 60 is approximately the width of first portion 190. For example, distance 154 may equal 1.0 mm and first portion 190 may be 1.8 mm long. Accordingly, the chip formed may be approximately 1.8 mm long.

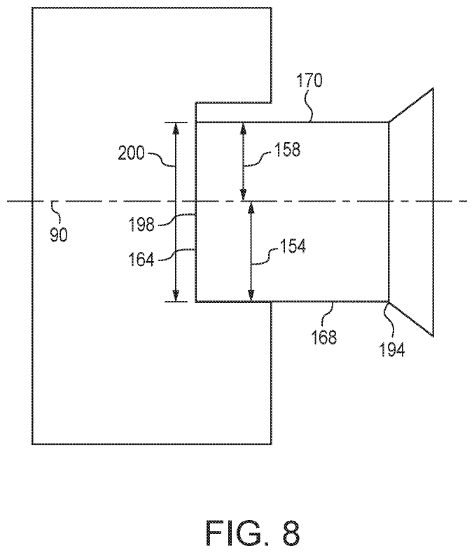

FIG. 8 is an alternative embodiment of cutting tooth 68. In the alternative embodiment, cutting surface 164 may extend from a first point 194 on cutting tooth 68 along lower surface 168 of cutting tooth 68, and along a substantially flat surface 198. Lower surface 168 of cutting tooth 68 is positioned the first distance 154 from rotational plane 90. The alternative embodiment of cutting tooth 68 also includes non-cutting surface 170, positioned the second distance 158 from rotational plane 90. In contrast to the embodiment shown in FIG. 6, in the alternative embodiment of cutting tooth 68, cutting surface 164 does not extend from point 166, but rather, extends along flat surface 198. In the alternative embodiment, cutting surface 164 cuts a second portion 200 of groove 16, which overlaps first portion 190.

A chip formed by the alternative embodiment of cutting tooth 68 is approximately the width of second portion 200. For example, distance 154 may equal 1.0 mm and second portion 200 may be 1.8 mm long. Accordingly, the chip formed may be approximately 1.8 mm long.

In operation, cutting surfaces 148 of the alternative embodiment of the first plurality of cutting teeth (shown in FIG. 7) cut the first portion 190 of a groove, for example, groove 16. Moreover, cutting surfaces 164 of the second plurality of cutting teeth (shown in FIG. 8) cut second portion 200 of groove 16. The width of groove 16 is defined by the first distance 154 in the first axial direction from the rotational plane 90 combined with the first distance 154 in the second axial direction from the rotational plane 90. In the exemplary embodiment where first distance 154 equals 1.0 mm, the final width of groove 16 would be 2.0 mm. Notably, the 2.0 mm groove is cut while producing chips that are approximately 1.8 mm wide. The narrower chips are less likely to become stuck and/or wedged within groove 16 than a chip that is approximately the same width as the groove. Producing chips that are narrower than the final width of the groove reduces the number of chips stuck and/or wedged within the groove after machining.

The embodiments described herein include a cutting tool configured to cut grooves into an interior surface of a work piece. The chips formed during machining of the grooves are narrower than the final width of the grooves, which reduces the number of chips stuck and/or wedged within the groove after machining. The cutting tools described herein facilitate efficient machining of grooves within a work piece including efficient removal of unwanted material.

Although described herein with respect to a groove cutting process, the cutting tools described herein may be used in other machining operations. For example, the cutting tools described herein may be used in any machining operation that produces chips that occasionally become stuck/wedged within a cut produced by the tool.

Having described aspects of the disclosure in terms of various examples with their associated operations, it will be apparent that modifications and variations are possible without departing from the scope of the disclosure as defined in the appended claims. That is, aspects of the disclosure are not limited to the specific examples described herein, and all matter contained in the above description and shown in the accompanying drawings shall be interpreted as illustrative and not in a limiting sense.

The embodiment of the invention has been provided as an example, and has not been provided to limit the scope of the invention. The embodiment may be embodied in various other forms and can be subjected to a variety of omissions, replacements, and changes without departing from the gist of the invention. The embodiment and the modifications thereof belong to the scope or gist of the invention and also belong to the scope of the invention equivalent to the appended claims.

Components of the systems and/or operations of the methods described herein may be utilized independently and separately from other components and/or operations described herein. Moreover, the methods described herein may include additional or fewer operations than those disclosed, and the order of execution or performance of the operations described herein is not essential unless otherwise specified. That is, the operations may be executed or performed in any order, unless otherwise specified, and it is contemplated that executing or performing a particular operation before, contemporaneously with, or after another operation is within the scope of the disclosure. Although specific features of various examples of the disclosure may be shown in some drawings and not in others, this is for convenience only. In accordance with the principles of the disclosure, any feature of a drawing may be referenced and/or claimed in combination with any feature of any other drawing.

When introducing elements of the disclosure or the examples thereof, the articles “a,” “an,” “the,” and “said” are intended to mean that there are one or more of the elements. References to an “embodiment” or an “example” of the present disclosure are not intended to be interpreted as excluding the existence of additional embodiments or examples that also incorporate the recited features. The terms “comprising,” “including,” and “having” are intended to be inclusive and mean that there may be elements other than the listed elements. The phrase “one or more of the following: A, B, and C” means “at least one of A and/or at least one of B and/or at least one of C.”

The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A cutting tool, comprising:
a substantially circular body configured to rotate about a rotational axis;
a first plurality of cutting teeth each extending substantially radially outwardly from said body, each cutting tooth of said first plurality of cutting teeth comprises a cutting section and a non-cutting section, wherein said cutting section is positioned on a first side of a rotational plane that extends radially outwardly from the rotational axis and said non-cutting section is positioned on a second, opposite side of the rotational plane; and
a second plurality of cutting teeth each extending radially outwardly from said body, each cutting tooth of said second plurality of cutting teeth comprises a cutting section and a non-cutting section, wherein said cutting section is positioned on the second side of the rotational plane and said non-cutting section is positioned on the first side of the rotational plane;
wherein each said cutting section comprises a cutting surface positioned a first distance from the rotational plane and each said non-cutting section comprises a non-cutting surface positioned a second distance from the rotational plane.

2. A cutting tool in accordance with claim 1, wherein the second distance is less than the first distance.

3. A cutting tool in accordance with claim 1, wherein the first distance in the first axial direction from the rotational plane combined with the first distance in the second axial direction from the rotational plane equals a final width of a groove cut by said cutting tool.

4. A cutting tool in accordance with claim 3, wherein a width of said cutting surface of said first plurality of cutting teeth is less than the final width of the groove cut by said cutting tool.

5. A cutting tool in accordance with claim 3, wherein a width of said cutting surface of said second plurality of cutting teeth is less than the final width of the groove cut by said cutting tool.

6. A cutting tool in accordance with claim 1, wherein said first plurality of cutting teeth comprises a first cutting tooth, a second cutting tooth, a third cutting tooth, and a fourth cutting tooth, and said second plurality of cutting teeth comprises a fifth cutting tooth, a sixth cutting tooth, a seventh cutting tooth, and an eighth cutting tooth.

7. A cutting tool in accordance with claim 6, wherein:
said first cutting tooth is positioned on a radially opposite side of said body as said third cutting tooth; and
said second cutting tooth is positioned on a radially opposite side of said body as said fourth cutting tooth.

8. A cutting tool in accordance with claim 6, wherein:
said fifth cutting tooth is positioned on a radially opposite side of said body as said seventh cutting tooth; and
said sixth cutting tooth is positioned on a radially opposite side of said body as said eighth cutting tooth.

9. A cutting tool in accordance with claim 1, wherein each of said first plurality of cutting teeth alternates with said second plurality of cutting teeth around the circumference of said body.

10. A cutting tool in accordance with claim 1, wherein said cutting surface is at an angle of less than 90 degrees with respect to the rotational plane.

11. (canceled)

12. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A cutting tool in accordance with claim 1, wherein said cutting surface is substantially perpendicular to the rotational plane.

22. A groove cutting device comprising:
a spindle coupled to a motor for rotating the spindle about a rotational axis and in an orbital motion;
a cutting tool coupled to the spindle, the cutting tool comprising:
a substantially circular body configured to rotate about a rotational axis;
a first plurality of cutting teeth each extending substantially radially outwardly from the body, each cutting tooth of the first plurality of cutting teeth comprises a cutting section and a non-cutting section, wherein the cutting section is positioned on a first side of a rotational plane that extends radially outwardly from the rotational axis of the cutting device and the non-cutting section is positioned on a second, opposite side of the rotational plane; and
a second plurality of cutting teeth each extending radially outwardly from the body, each cutting tooth of the second plurality of cutting teeth comprises a cutting section and a non-cutting section, wherein the cutting section is positioned on the second side of the rotational plane and the non-cutting section is positioned on the first side of the rotational plane;
wherein each cutting section comprises a cutting surface positioned a first distance from the rotational plane and each non-cutting section comprises a non-cutting surface positioned a second distance from the rotational plane.

23. A groove cutting device in accordance with claim 22, wherein a diameter of the cutting tool is less than a diameter of an opening within a work piece so that the cutting tool can be lowered and removed from the opening without interference.

24. A groove cutting device in accordance with claim 22, wherein the orbital motion allows the cutting tool to orbit around a wall of the work piece such that the desired grooves are cut around the entire wall, or into all wall projections.

25. A groove cutting device in accordance with claim 22, wherein the second distance is less than the first distance.

26. A groove cutting device in accordance with claim 22, wherein the first distance in the first axial direction from the rotational plane combined with the first distance in the second axial direction from the rotational plane equals a final width of a groove cut by the cutting device.

27. A groove cutting device in accordance with claim 26, wherein a width of the cutting surface of the first plurality of cutting teeth is less than the final width of the groove cut by the cutting tool.

28. A groove cutting device in accordance with claim 26, wherein a width of the cutting surface of the second plurality of cutting teeth is less than the final width of the groove cut by the cutting tool.

29. A groove cutting device in accordance with claim 22, wherein the first plurality of cutting teeth comprises a first cutting tooth, a second cutting tooth, a third cutting tooth, and a fourth cutting tooth, and the second plurality of cutting teeth comprises a fifth cutting tooth, a sixth cutting tooth, a seventh cutting tooth, and an eighth cutting tooth.

30. A groove cutting device in accordance with claim 22, wherein:
the first cutting tooth is positioned on a radially opposite side of the body as the third cutting tooth; and
the second cutting tooth is positioned on a radially opposite side of the body as the fourth cutting tooth.

31. A groove cutting device in accordance with claim 22, wherein:
the fifth cutting tooth is positioned on a radially opposite side of the body as the seventh cutting tooth; and
the sixth cutting tooth is positioned on a radially opposite side of the body as the eighth cutting tooth.

32. A groove cutting device in accordance with claim 22, wherein each of the first plurality of cutting teeth alternates with the second plurality of cutting teeth around the circumference of the body.
